(19) United States
(12) Patent Application Publication
(10) Pub. No.: US 2025/0249928 A1
(43) Pub. Date: Aug. 7, 2025

(54) CONTROL APPARATUS, CONTROL METHOD, AND STORAGE MEDIUM

(71) Applicant: HONDA MOTOR CO., LTD., Tokyo (JP)

(72) Inventor: Yoshimitsu MURAHASHI, Tokyo (JP)

(21) Appl. No.: 19/043,542

(22) Filed: Feb. 3, 2025

(30) Foreign Application Priority Data
Feb. 6, 2024 (JP) 2024-016639

(51) Int. Cl. B60W 60/00; B60W 10/18; B60W 10/20; B60W 50/00

(52) U.S. Cl. CPC B60W 60/001; B60W 10/18; B60W 10/20; B60W 50/0097; B60W 2050/0083; B60W 2540/18; B60W 2556/20

(57) ABSTRACT

A vehicle control apparatus 1 is provided with a target control amount calculation section 11. The target control amount calculation section 11 includes: an input information obtainment section 2 that obtains input information as of M (M is an integer) different times in a prescribed amount of time before the current time; control amount predictors 3₀, . . . 3_{M-1} that each calculate a predicted control amount based on the input information; and a weighted average calculator 4 that calculates, as a target control amount, a weighted average value of the M predicted control amounts calculated by the control amount predictors. An i-th (i is an integer between 0 through M−1) control amount predictor 3ᵢ calculates a predicted control amount by using a control amount prediction model that associates input information as of an amount of prediction time τᵢ before the current time with a control amount as of the current time.

This application is based on and claims the benefit of priority from Japanese Patent Application No. 2024-016639, filed on 6 Feb. 2024, the content of which is incorporated herein by reference.

### BACKGROUND OF THE INVENTION

### Field of the Invention

The present invention pertains to a control apparatus, a control method, and a storage medium. In more detail, the present invention pertains to a control apparatus, a control method, and a storage medium that are for controlling a control amount defined for a control subject.

### Related Art

In recent years, there have been greater efforts to provide access to a sustainable transport system that considers people in weak positions, from among traffic participants. Towards realizing this, focus is being given to research and development for further improving traffic safety or convenience through research and development pertaining to automatic driving techniques.

For example, Japanese Unexamined Patent Application, Publication No. 2021-126925 describes an automatic driving technique in which a control apparatus automatically controls a steering angle without relying on a steering operation by a driver. The control apparatus described in Japanese Unexamined Patent Application, Publication No. 2021-126925 determines a target steering angle with respect to a steering angle for a vehicle such that the vehicle is caused to travel along an arc that passes through the current location of the vehicle and a target location that is defined on a target route.
Patent Document 1: Japanese Unexamined Patent Application, Publication No. 2021-126925

### SUMMARY OF THE INVENTION

Incidentally, in many automatic driving techniques, a target control amount (a target steering angle in the example of Japanese Unexamined Patent Application, Publication No. 2021-126925) with respect to a control amount is calculated based on information obtained by, inter alia, an external sensor such as a camera or a radar that is mounted to a vehicle. However, information obtained using such an external sensor includes observation noise or defects. Therefore, there are cases where the target control amount oscillates due to being impacted by noise or defects in the external sensor.

An FIR filter is publicly known as a means for smoothing such oscillation in a target control amount. However, while it is possible to realize smoothing when an FIR filter is employed, a delay arises (refer to FIG. 4, which is described below).

An object of the present invention is to provide a control apparatus, a control method, and a storage medium that enable control having little delay to be realized while suppressing an impact due to noise or defects in input information. A consequent object of the present invention is to contribute to the development of a sustainable transport system.

(1) A control apparatus (for example, a later-described vehicle control apparatus 1, 1A, 1B) according to the present invention calculates, based on input information, a target control amount with respect to a control amount defined for a control subject (for example, a later-described braking apparatus 7, power plant 8, and electric power-steering apparatus 9), operates the control subject based on the target control amount, and is characterized by including: a target control amount calculator (for example, a later-described target control amount calculation section 11, 11A, 11B) configured to calculate the target control amount based on time series data for the input information; and an automatic operator (for example, a later-described motor drive section 12) configured to operate the control subject based on the target control amount, the target control amount calculator including an input information obtainer (for example, a later-described input information obtainment section 2) configured to obtain the input information as of M (M is an integer greater than or equal to 2) different times during a prescribed amount of time before a current time, M control amount predictors (for example, later-described control amount predictors 3₀, 3₁, . . . , 3_{M-1}) each configured to calculate a predicted control amount based on the input information obtained by the input information obtainer, and a weighted average calculator (for example, a later-described weighted average calculator 4, 4A) configured to calculate, as the target control amount, a weighted average value of the M predicted control amounts calculated by the M control amount predictors, and an i-th (i is an integer between 0 through M−1) control amount predictor calculating the predicted control amount by using a control amount prediction model that associates the input information as of an i amount of time before the current time with the control amount as of the current time.

(2) In this case, it is desirable for the control amount prediction model to be constructed using machine learning in which input sample data that is time series data for the input information and ideal output data that is time series data for an ideal control amount with respect to the input sample data are employed as teaching data.

(3) In this case, it is desirable for an i-th control amount prediction model to be constructed using the teaching data, in which the input sample data and the ideal output data resulting from advancing time with respect to the input sample data by the i amount of time are employed as a set.

(4) In this case, it is desirable for the weighted average calculator to set an i-th weight for the predicted control amount calculated by the i-th control amount predictor to a value greater than a j-th (j is an integer greater than i) weight for the predicted control amount calculated by a j-th control amount predictor.

(5) In this case, it is desirable for the weighted average calculator to set a value for a k-th (k is an integer between 0 through M−1) weight such that the k-th weight exponentially decreases with respect to a value of k.

(6) In this case, it is desirable for the target control amount calculator to further include a reliability level obtainer (for example, a later-described reliability level obtainment section 2A) configured to obtain a reliability level of the input information as of the i amount of time before the current time, and the weighted average calculator to set the value of the i-th weight based on an i-th reliability level obtained by the reliability level obtainer.

(7) In this case, it is desirable for the control subject to be a steering mechanism (for example, a later-described electric power-steering apparatus 9) in a vehicle, the control amount to be a steering angle that is in accordance with the steering mechanism, and the input information to include external information pertaining to a periphery of the vehicle.

(8) In this case, it is desirable for the control subject to be a travel drive apparatus (for example, a later-described power plant 8) in a vehicle, the control amount to be a travel drive force that is in accordance with the travel drive apparatus, and the input information to include external information pertaining to a periphery of the vehicle.

(9) In this case, it is desirable for the control subject to be a brake (for example, a later-described braking apparatus 7) in a vehicle, the control amount to be a braking force in accordance with the brake, and the input information to include external information pertaining to a periphery of the vehicle.

(10) In this case, it is desirable for the control apparatus to further include a trainer configured to train the control amount prediction model based on time series data for the input information and the control amount as of a time of manual driving in which a driver of the vehicle is an agent who operates the control subject.

(11) A control method according to the present invention is a method that uses a computer to control a control amount defined for a control subject, characterized in that the control method includes: obtaining input information as of M (M is an integer that is greater than or equal to 2) different times during a prescribed amount of time before a current time; calculating M predicted control amounts based on the input information as of the M different times; calculating, as a target control amount for the control amount, a weighted average value of the M predicted control amounts; and operating the control subject based on the target control amount, and the calculating the M predicted control amounts includes calculating an i-th (i is an integer between 0 through M−1) predicted control amount by using a control amount prediction model that associates the input information as of an i amount of time before the current time with the control amount as of the current time.

(12) A storage medium according to the present invention stores a computer program for causing a computer to control a control amount defined for a control subject, the storage medium characterized in that the computer program causes the computer to perform operations that include: obtaining input information as of M (M is an integer that is greater than or equal to 2) different times during a prescribed amount of time before a current time, calculating M predicted control amounts based on the input information as of the M different times; calculating, as a target control amount for the control amount, a weighted average value of the M predicted control amounts, and operating the control subject based on the target control amount, and the calculating the M predicted control amounts includes calculating an i-th (i is an integer between 0 through M−1) predicted control amount by using a control amount prediction model that associates the input information as of an i amount of time before the current time with the control amount as of the current time.

(1) In the present invention, the target control amount calculator, based on time series data for the input information, calculates the target control amount for the control amount defined for the control subject, and the automatic operator operates the control subject based on the calculated target control amount. The target control amount calculator includes: an input information obtainer that obtains input information as of M different times in a prescribed amount of time before the current time; M control amount predictors that each calculate a predicted control amount based on the input information as of the M times; and a weighted average calculator that calculates, as the target control amount, a weighted average value of the M predicted control amounts calculated by the control amount predictors. By virtue of the present invention, the weighted average value of M predicted control amounts is calculated as the target control amount, whereby it is possible to suppress an impact due to noise or defects included in the input information, and calculate a target control amount that has little oscillation. In addition, in the present invention, the i-th (i is an integer between 0 through M−1) control amount predictor from among the total of M control amount predictor calculates a predicted control amount by using a control amount prediction model that associates input information as of a time that is an i amount of time before the current time (in other words, in a case where the current time is regarded as a 0-th point, the i-th time counted into the past from the current time) with a control amount as of the current time. In other words, the control amount predictors respectively calculate, as the predicted control amounts, the control amount for the same current time based on the input information as of the different times. Accordingly, by virtue of the present invention, it is possible to realize control having little delay while suppressing an impact due to noise or defects included in the input information, and it is consequently possible to contribute to the development of a sustainable transport system.

(2) In the present invention, each control amount predictor calculates a predicted control amount from the input information by using a control amount prediction model constructed using machine learning in which input sample data (time series data for the input information) and ideal output data (time series data for an ideal control amount with respect to the input sample data) are employed as teaching data. Accordingly, by virtue of the present invention, it is possible to realize ideal control that has little delay while suppressing the impact of noise or defects included in input information.

(3) In the present invention, the i-th control amount predictor calculates a predicted control amount as of the current time from input information as of an i amount of time before the current time by using an i-th control amount prediction model constructed using teaching data in which input sample data and the ideal output data resulting from advancing time with respect to the input sample data by the i amount of time are employed as a set. Accordingly, by virtue of the present invention, it is possible to realize ideal control that has little delay while suppressing the impact of noise or defects included in input information.

(4) In the present invention, the weighted average calculator sets an i-th weight for the predicted control amount calculated by the i-th control amount predictor to a value greater than a j-th (j is an integer greater than i) weight for the predicted control amount calculated by a j-th control amount predictor. In other words, the weighted average calculator sets the weight for the i-th predicted control amount, which is calculated based on input information as of the i amount of time before the current time, to a value greater than the weight for the j-th predicted control amount, which is calculated based on input information as of a j amount of time ago, which is further in the past. There is typically a tendency for the prediction accuracy of a predicted control amount to increase the closer the time of input information is to the current time. The weight is set to a greater value in alignment with the rise in prediction accuracy, whereby it is possible to calculate a target control amount that is highly accurate.

(5) In the present invention, the weighted average calculator sets a value for the k-th (k is an integer between 0 through M−1) weight such that the k-th weight exponentially decreases with respect to the value of k. As a result, it is possible to use a simple computation to calculate a target control amount that has high accuracy.

(6) In the present invention, the reliability level obtainer obtains a reliability level for input information as of the i amount of time before the current time, and the weighted average calculator sets a value for the i-th weight based on the obtained i-th reliability level. As a result, it is possible to calculate a highly accurate target control amount by reflecting the reliability levels for input information as of various times.

(7) In the present invention, the target control amount calculator, based on time series data for the input information that includes external information regarding the periphery of the vehicle, calculates a target control amount for a steering angle in accordance with the steering mechanism by using a procedure as described above, and the automatic operator operates the steering mechanism based on the calculated target control amount. Accordingly, by virtue of the present invention, it is possible to realize steering control that has little delay while suppressing the impact of noise or defects included in time series data for external information.

(8) In the present invention, the target control amount calculator, based on time series data for the input information that includes external information regarding the periphery of the vehicle, calculates a target control amount for a travel drive force in accordance with the travel drive apparatus by using a procedure as described above, and the automatic operator operates the travel drive apparatus based on the calculated target control amount. Accordingly, by virtue of the present invention, it is possible to realize travel drive force control that has little delay while suppressing the impact of noise or defects included in external information.

(9) In the present invention, the target control amount calculator, based on time series data for the input information that includes external information regarding the periphery of the vehicle, calculates a target control amount for a braking force in accordance with the brake by using a procedure as described above, and the automatic operator operates the brake based on the calculated target control amount. Accordingly, by virtue of the present invention, it is possible to realize braking control that has little delay while suppressing the impact of noise or defects included in time series data for external information.

(10) In the present invention, the trainer trains the control amount prediction model based on time series data for the input information and the control amount as of a time of manual driving in which a driver of the vehicle is an agent who operates the control subject. Accordingly, by virtue of the present invention, it is possible to cause an input/output characteristic of the control amount prediction model to change in accordance with change over time by characteristics of the driver of the vehicle V or by characteristics of the external sensor, which is for obtaining external information.

(11) By virtue of the control method according to the present invention, the same effect as that of the control apparatus described above is achieved.

(12) By virtue of the storage medium according to the present invention, the same effect as that of the control apparatus described above is achieved.

### BRIEF DESCRIPTION OF THE DRAWINGS

FIG. 1 is a view that schematically illustrates a configuration of a vehicle control apparatus according to a first embodiment of the present invention, and a vehicle to which the vehicle control apparatus is mounted;

FIG. 2 is a view that illustrates a configuration of an automatic steering control module from among the vehicle control apparatus;

FIG. 3 is a view that compares a target control amount calculated by target control amount calculation sections among comparative example 1 (upper level), comparative example 2 (middle level), and the present embodiment (lower level);

FIG. 4 is a view that schematically illustrates a configuration of teaching data;

FIG. 5 is a view that schematically illustrates a configuration of teaching data in circumstances of using machine learning to construct M control amount prediction models;

FIG. 6 is a view that illustrates a configuration of an automatic steering control module in a vehicle control apparatus according to a second embodiment of the present invention; and

FIG. 7 is a view that illustrates a configuration of an automatic steering control module in a vehicle control apparatus according to a third embodiment of the present invention.

### DETAILED DESCRIPTION OF THE INVENTION

### First Embodiment

With reference to the drawings, description is given below regarding a vehicle control apparatus according to a first embodiment of the present invention.

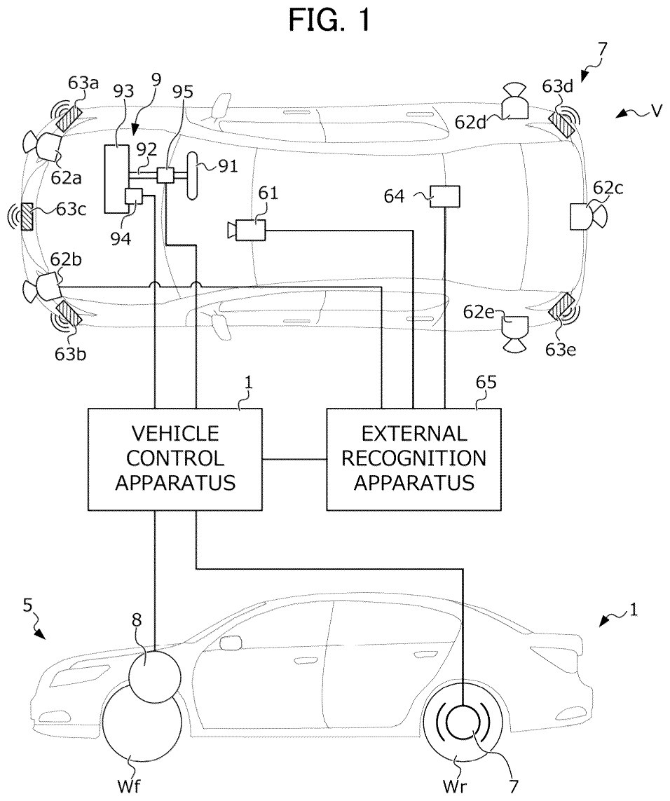

FIG. 1 is a view that schematically illustrates a configuration of a vehicle control apparatus 1 according to the present embodiment, and a vehicle V to which the vehicle control apparatus 1 is mounted. The upper level in FIG. 1 illustrates a plan view of the vehicle V, and the lower level in FIG. 1 illustrates a side surface view thereof. Note that description is given below regarding a case where the vehicle V is a so-called right-hand drive four-wheeled vehicle in which the driver's seat that the driver sits on is provided on the right side in the vehicle width direction seen along the direction of progression, but the present invention is not limited to this case. The vehicle V may be a so-called left-hand drive four-wheeled vehicle in which the driver's seat is provided on the left side in the vehicle width direction seen along the direction of progression.

The vehicle V is provided with: an electric power-steering apparatus 9, which corresponds to a steering mechanism for steering left and right front wheels Wf; a power plant 8, which corresponds to a travel drive apparatus for generating a travel drive force for causing the front wheels Wf that are drive wheels in the vehicle V to rotate; a braking apparatus 7 that generates a braking force for causing rotation by the front wheels Wf and rear wheels Wr to stop; a sensor unit 6 that is provided to the vehicle body; and the vehicle control apparatus 1 that controls the electric power-steering apparatus 9, the power plant 8, and the braking apparatus 7 based on, inter alia, a driving operation (for example, a steering operation, an acceleration/deceleration operation, a braking operation, or the like) by the driver or a detection signal from the sensor unit 6.

The electric power-steering apparatus 9 is provided with a gearbox 93 that connects the left and right front wheels Wf with a pinion shaft 92 that extends from a steering wheel 91 that receives a steering operation by the driver, an electric motor 94 provided to the gearbox 93, and a steering sensor 95 that detects the steering angle of the steering wheel 91.

The gearbox 93 is provided with a rack shaft that extends along the vehicle width direction and engages with the pinion shaft 92, a tie rod that connects the left and right front wheels Wf with both ends of the rack shaft, and the like. The gearbox 93 converts rotational motion of the steering wheel 91 that is due to a steering operation by the driver into motion along the vehicle width direction to thereby cause the left and right front wheels Wf to change course toward the direction of progression. The electric motor 94 rotates in accordance with a control signal outputted from the vehicle control apparatus 1, and generates a drive force that is for assisting a steering operation by the driver, or for automatically steering the front wheels Wf without relying on a steering operation by the driver. The steering sensor 95 detects the steering angle of the steering wheel 91, and transmits a signal that correspond to a detection value to the vehicle control apparatus 1.

The power plant 8 is a drive force generation source that, in response to a control signal outputted from the vehicle control apparatus 1 or an acceleration/deceleration operation on an accelerator pedal (not illustrated) by the driver, generates a travel drive force for causing the front wheels Wf to rotate in order to cause the vehicle V to move forward or move backward along the direction of progression. Description is given below regarding a case in which a drive motor that generates a travel drive force by consuming electric power supplied from, inter alia, a high-voltage battery or a fuel cell stack (not illustrated) is used as the power plant 8, but the present invention is not limited to this case. An engine that generates the travel drive force by consuming fuel stored in a fuel tank (not illustrated) and a transmission that changes an output from the engine and transmits the changed output to the front wheels Wf may be used as the power plant 8.

The braking apparatus 7 is provided with: a disc brake apparatus that—based on a control signal outputted from the vehicle control apparatus 1, a braking operation on a brake pedal (not illustrated) by the driver, or the like—compresses discs provided to the axles of the wheels Wf, Wr to thereby generate a braking force in order to cause rotation by the wheels Wf, Wr to decelerate or stop, primarily at a time of travel; a parking brake that, primarily when parking, generates a braking force for maintaining a state in which rotation by the wheels Wr, Wf has been stopped; and the like.

The sensor unit 6 is provided with: a camera unit 61; a plurality of (for example, five) LIDAR units 62a, 62b, 62c, 62d, 62e; a plurality of (for example, five) radar units 63a, 63b, 63c, 63d, 63e; a vehicle body sensor 64; and an external recognition apparatus 65.

The camera unit 61 is a camera that captures forward of the vehicle V. The camera unit 61 is attached to a position that is close to the front window, on a vehicle interior side of the roof of the vehicle V, for example. An image captured by the camera unit 61 is transmitted to the external recognition apparatus 65.

The LIDAR units 62a to 62e are each a LIDAR (Light Detection and Ranging) that detects a subject in the periphery of the vehicle V by measuring scattered light from the subject as a result of illuminating the subject by a laser that emits light in pulses. The first LIDAR unit 62a is provided on a right corner side seen along the direction of progression in a front portion of the vehicle V, and detects a subject that is forward and slightly on the right side in the periphery of the vehicle V. The second LIDAR unit 62b is provided on a left corner side seen along the direction of progression in a front portion of the vehicle V, and detects a subject that is forward and slightly on the left side in the periphery of the vehicle V. The third LIDAR unit 62c is provided in the center in the vehicle width direction at a rear portion of the vehicle V, and detects a subject that is rearward in the periphery of the vehicle V. The fourth LIDAR unit 62d is provided on a rearward side at a right-side portion of the vehicle V, and detects a subject that is rightward and slightly rearward in the periphery of the vehicle V. The fifth LIDAR unit 62e is provided on a rearward side at a left-side portion of the vehicle V, and detects a subject that is leftward and slightly rearward in the periphery of the vehicle V. Detection signals from these LIDAR units 62a to 62e are transmitted to the external recognition apparatus 65.

The radar units 63a to 63e are each a millimeter-wave radar that detects a subject in the periphery of the vehicle V by measuring a wave that is reflected by a target object as a result of the target object being illuminated by a millimeter wave. The first radar unit 63a is provided on a right corner side seen along the direction of progression in a front portion of the vehicle V, and detects a subject that is forward and slightly on the right side in the periphery of the vehicle V. The second radar unit 63b is provided on a left corner side seen along the direction of progression in a front portion of the vehicle V, and detects a subject that is forward and slightly on the left side in the periphery of the vehicle V. The third radar unit 63c is provided in the center in the vehicle width direction in a front portion of the vehicle V, and detects a subject that is forward in the periphery of the vehicle V. The fourth radar unit 63d is provided on a right corner side seen along the direction of progression in a rear portion of the vehicle V, and detects a subject that is rearward and slightly on the right side in the periphery of the vehicle V. The fifth radar unit 63e is provided on a left corner side seen along the direction of progression in a rear portion of the vehicle V, and detects a subject that is rearward and slightly on the left side in the periphery of the vehicle V. Detection signals from these radar units 63a to 63e are transmitted to the external recognition apparatus 65.

The vehicle body sensor 64 transmits, to the external recognition apparatus 65, a signal that corresponds to a motion state of the vehicle body, such as the vehicle speed or acceleration of the vehicle V.

The external recognition apparatus 65 is a computer that performs a sensor fusion process on detection results from the camera unit 61, the LIDAR units 62a to 62e, the radar units 63a to 63e, the vehicle body sensor 64, and the like to thereby recognize, inter alia, external information that pertains to the periphery of the vehicle V (the position, distance, and relative speed of obstacles or other vehicles, the type or position of demarcation lines, or the like) or host vehicle state information that pertains to the motion state of the vehicle V (such as the vehicle speed, direction of progression, and acceleration), and also evaluates the level of reliability of such recognition results. The external recognition apparatus 65 transmits information pertaining to these recognition results, information pertaining to the level of reliability of these recognition results, and the like to the vehicle control apparatus 1.

The vehicle control apparatus 1 is a computer configured by hardware that includes an arithmetic processing means such as a CPU, an auxiliary storage means such as an HDD or an SSD that stores various programs, and a main storage means such as a RAM that stores data which is temporarily necessary for the arithmetic processing means to execute a program. In the vehicle control apparatus 1, such a hardware configuration is used to configure an automatic steering control module that sets the electric power-steering apparatus 9 as a control subject to control the electric power-steering apparatus 9, an automatic travel drive control module that sets the power plant 8 as a control subject to control the power plant 8, and an automatic braking control module that sets the braking apparatus 7 as a control subject to control the braking apparatus 7.

Based on input information obtained from the external recognition apparatus 65, the automatic steering control module in the vehicle control apparatus 1 calculates a target control amount for a control amount defined for the electric power-steering apparatus 9 (for example, a steering angle), and operates the electric power-steering apparatus 9 such that the control amount in the electric power-steering apparatus 9 becomes the target control amount.

Based on the input information obtained from the external recognition apparatus 65, the automatic travel drive control module in the vehicle control apparatus 1 calculates a target control amount for a control amount defined for the power plant 8 (for example, a travel drive force), and operates the power plant 8 such that the control amount in the power plant 8 becomes the target control amount.

Based on the input information obtained from the external recognition apparatus 65, the automatic braking control module in the vehicle control apparatus 1 calculates a target control amount for a control amount defined for the braking apparatus 7 (for example, a braking force), and operates the braking apparatus 7 such that the control amount in the braking apparatus 7 becomes the target control amount.

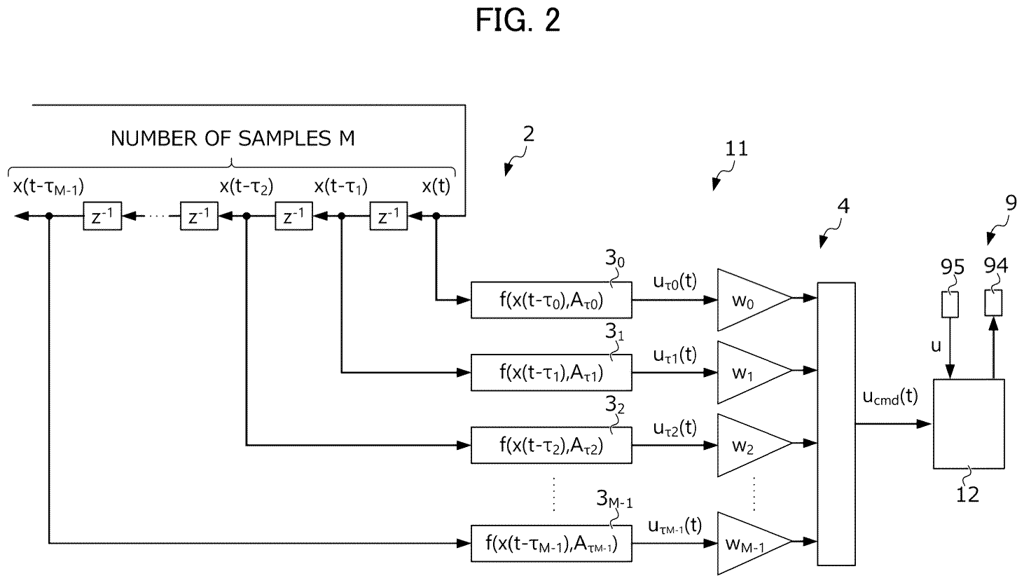

FIG. 2 is a view that illustrates a configuration of the automatic steering control module that pertains to control of the electric power-steering apparatus 9, from among the vehicle control apparatus 1. Note that, because the configurations of the automatic travel drive control module and the automatic braking control module are substantially the same as the configuration of the automatic steering control module illustrated in FIG. 2, detailed description thereof is omitted.

The vehicle control apparatus 1 is provided with: a target control amount calculation section 11 that, based on the input information (referred to as “x” below) transmitted from the external recognition apparatus 65, calculates a target control amount (referred to “u_{cmd}” below) for a control amount (referred to “u” below) outputted from the steering sensor 95 in the electric power-steering apparatus 9; and a motor drive section 12 that operates the electric motor 94 in the electric power-steering apparatus 9 based on the target control amount u_{cmd} calculated by the target control amount calculation section 11.

Note that variables as of a time t are referred to by parentheses below. In other words, the input information, control amount, and target control amount as of the time t are respectively referred to as x(t), u(t), and u_{cmd}(t).

The motor drive section 12, based on a known feedback control algorithm, operates the electric motor 94 (in other words, adjusts a drive current for the electric motor 94) such that the target control amount u_{cmd}, which is calculated in the target control amount calculation section 11 using a procedure described below, and the control amount u outputted from the steering sensor 95 match.

The target control amount calculation section 11 is provided with an input information obtainment section 2, a plurality of control amount predictors 3₀, 3₁, . . . , 3_{M-1}, and a weighted average calculator 4.

The input information obtainment section 2 obtains time series data for the input information x, which is necessary in order to control the control subject, from a result of recognition in the external recognition apparatus 65. Note that, as indicated in the following formula (1), the input information x obtained in the input information obtainment section 2 is set as an N-dimensional vector configured by N (N is an integer greater than or equal to 2) input variables (x₁, x₂, . . . x_{N}) such as demarcation line position information, the vehicle-to-vehicle distance with respect to the vehicle ahead, and speed relative to the vehicle ahead.

$$x ( t ) = [ {x}_{1} ( t ) , {x}_{2} ( t ) , … , {x}_{N} ( t ) ] \qquad ( 1 )$$

The input information obtainment section 2 obtains, from the external recognition apparatus 65, input information as of M different times (M is an integer greater than or equal to 2, and may be referred to as “number of samples” below) during a prescribed amount of time before the current time. In other words, in a case where the current time is referred to as “t” and an amount of sampling time is referred to as “Δt”, the input information obtainment section 2 obtains input information [x(t−τ₀), x(t−τ₁), x(t−τ₂), . . . x(t−τ_{M-1})] as of M different times [t−τ₀, t−τ₁, t−τ₂, . . . , t−τ_{M-1}] in a prescribed amount of time Δt×(M−1) before the current time t. Note that in a case below where a discretionary integer between 0 through M−1 is given as “i”, the difference between the current time t and the time t−Δt×i for the i-th point before the current time t is referred to as “τᵢ”, and may be simply referred to as an i amount of time.

The input information obtainment section 2 is connected to the control amount predictors 3₀, 3₁, 3₂, . . . , 3_{M-1} in the same number as the number of samples M for the input information obtainment section 2, as illustrated in FIG. 2. The control amount predictors 3₀, 3₁, 3₂, . . . , 3_{M-1} respectively calculate predicted control amounts [u_{τ0}(t), u_{τ1}(t), u_{τ2}(t), . . . , u_{τM-1}(t)] as of the same current time t, based on the input information [x(t−τ₀), x(t−τ₁), x(t−τ₂), . . . x(t−τ_{M-1})] that is as of the different times [t−τ₀, t−τ₁, t−τ₂, . . . , t−τ_{M-1}] and was obtained by the input information obtainment section 2.

Note that, below, a control amount predictor 3ᵢ that calculates a predicted control amount u_{τi}(t) based on input information x(t−τ₁) as of the i amount of time before the current time t is referred to as the i-th control amount predictor, and the predicted control amount u_{τi}(t) calculated by this i-th control amount predictor 3ᵢ is referred to as the i-th predicted control amount. In addition, a time difference τᵢ between an input x(t−τ₁) and an output u_{τi}(t) with respect to the i-th control amount predictor 3ᵢ is referred to below as an amount of prediction time.

In other words, the 0-th control amount predictor 3₀, based on the input information x(t) as of the current time t, calculates a prediction value for the control amount as of the current time t as a 0-th predicted control amount u_{τ0}(t). The 1st control amount predictor 3₁, based on the input information x(t−τ₁) as of an amount of prediction time τ₁ before the current time t, calculates a prediction value for the control amount as of the current time t as a 1st predicted control amount u_{τ1}(t). The 2nd control amount predictor 3₂, based on the input information x(t−τ₂) as of an amount of prediction time τ₂ before the current time t, calculates a prediction value for the control amount as of the current time t as a 2nd predicted control amount u_{τ2}(t). In addition, the M−1-th control amount predictor 3_{M-1}, based on the input information x(t−τ_{M-1}) as of an amount of prediction time τ_{M-1} before the current time t, calculates a prediction value for the control amount as of the current time t as an M−1-th predicted control amount u_{τM-1}(t).

In addition, the M control amount predictors 3₀, 3₁, 3₂, . . . , 3_{M-1} are each provided with a control amount prediction model that associates input information as of an amount of prediction time before the current time with a control amount as of the current time, and uses the control amount prediction model to calculate a predicted control amount. In other words, the i-th control amount predictor 3ᵢ is provided with an i-th control amount prediction model that associates the input information x(t−τ₁) an amount of prediction time τᵢ before the current time t with the control amount u(t) as of the current time t, and uses the i-th control amount prediction model to calculate the i-th predicted control amount u_{τi}(t) from the input information x(t−τᵢ).

Below, an input/output characteristic of the i-th control amount prediction model is represented by a function f that employs the input information x(t−τ₁) as an explanatory variable and employs the predicted control amount u_{τi}(t) as an object variable, as indicated in the following formula (2). Note that “A_{τi}” in the following formula (2) is a parameter that characterizes an input/output characteristic of the i-th control amount prediction model. In other words, as described later, in a case where the control amount prediction model is constructed using a neural network, “A_{τi}” corresponds to a plurality of weighting coefficients that characterize an input/output characteristic of the neural network.

$${u}_{τ i} ( t ) = f ( x ( t - {τ}_{i} ) , {A}_{τ i} ) \qquad ( 2 )$$

The weighted average calculator 4 calculates, as a target control amount u_{cmd}(t), a weighted average value of the M predicted control amounts [u_{τ0}(t), u_{τ1} (t), u_{τ2} (t), . . . , u_{τM-1}(t)] calculated using the M control amount predictors 3₀, 3₁, 3₂, . . . , 3_{M-1} as indicated in the following formula (3), and inputs the target control amount u_{cmd}(t) to the motor drive section 12.

$${u}_{c m d} ( t ) = {\sum }_{k = 0}^{M - 1} {w}_{k} {u}_{τ k} ( t ) = {\sum }_{k = 0}^{M - 1} {w}_{k} f ( x ( t - {τ}_{k} ) , {A}_{τ k} ) \qquad ( 3 )$$

In the above-described formula (3), “wₖ” is a weight for the k-th (k is an integer between 0 through M−1) predicted control amount u_{τk}(t), and may be referred to as the k-th weight below. In addition, there is a tendency for the reliability of the predicted control amount u_{τk}(t) to increase the shorter an amount of prediction time τₖ. Accordingly, it is desirable for the weighted average calculator 4 to set an i-th weight wᵢ to a value greater than a j-th (j is an integer greater than i) weight wⱼ. In other words, it is desirable for the weighted average calculator 4 to set the weight wₖ for the predicted control amount u_{τk}(t) to a smaller value the longer the amount of prediction time τₖ. More specifically, it is desirable for the weighted average calculator 4 to set a value for the k-th weight wₖ such that the k-th weight wₖ exponentially decreases with respect to the value k, as indicated in the following formulas (4-1) through (4-3), for example. Note that, in the following formula (4-1), “β” is a positive time constant.

$${w}_{k}^{′} = exp ( - k / β ) \qquad ( 4 - 1 )$$

$$α = {\sum }_{k = 0}^{M - 1} {w}_{k}^{′} \qquad ( 4 - 2 )$$

$${w}_{k} = {w}_{k}^{′} / α \qquad ( 4 - 3 )$$

Next, description is given regarding a procedure for controlling a control amount defined for a control subject, in the vehicle control apparatus 1 as above. Firstly, the input information obtainment section 2 obtains the input information [x(t−τ₀), x(t−τ₁), x(t−τ₂), . . . x(t−τ_{M-1})] as of M different times in the prescribed amount of time τ_{M-1} before the current time t. Next, the M control amount predictors 3₀, 3₁, 3₂, . . . , 3_{M-1} calculate the M predicted control amounts [u_{τ0}(t), u_{τ1}(t), u_{τ2}(t), . . . , u_{τM-1}(t)], based on the input information [x(t−τ₀), x(t−τ₁), x(t−τ₂), . . . x(t−τ_{M-1})] that is as of the M different times and was obtained by the input information obtainment section 2. More specifically, the i-th control amount predictor 3ᵢ uses the i-th control amount prediction model, which associates the input information x(t−τᵢ) as of an amount of prediction time τᵢ before the current time t with the control amount u(t) as of the current time t, to calculate the i-th predicted control amount u_{τi}(t).

Next, the weighted average calculator 4 calculates, as the target control amount u_{cmd}(t), a weighted average value of the M predicted control amounts [u_{τ0}(t), u_{τ1}(t), u_{τ2}(t), . . . , u_{τM-1}(t)] that are calculated using the control amount predictors 3₀, 3₁, 3₂, . . . , 3_{M-1}. In addition, the motor drive section 12 operates the control subject, based on a known feedback control algorithm, such that the target control amount u_{cmd}(t) calculated using the above procedure and the control amount u(t) outputted from the steering sensor 95 match. The vehicle control apparatus 1 repeatedly executes a step such as the above every prescribed amount of time (for example, the amount of sampling time Δt) to thereby control the control subject.

Next, description is given regarding effects realized in a case where the target control amount u_{cmd}(t) is calculated using the target control amount calculation section 11 as above, while making comparisons to comparative examples 1 and 2. A target control amount calculation section in comparative example 1 refers to one that calculates a target control amount u_{cmd}(t) based on only an input variable x(t). In other words, the target control amount u_{cmd}(t) calculated by the target control amount calculation section in comparative example 1 is equal to the 0-th predicted control amount u_{τ0}(t) calculated by the 0-th control amount predictor 3₀ in the target control amount calculation section 11 illustrated in FIG. 2. In addition, a target control amount calculation section in comparative example 2 refers to one that employs, as a target control amount u_{cmd}(t), a result obtained by applying an FIR filter having the number of samples M to the output of the target control amount calculation section in comparative example 1. In other words, in a case where the output in comparative example 1 as of an amount of time τᵢ (i is an integer between 0 through M−1) before the current time t is given as y_{τi}(t), the target control amount u_{cmd}(t) in comparative example 2 is expressed by the following formula (5).

$${u}_{c m d} ( t ) = {\sum }_{i = 0}^{M - 1} {w}_{k} {y}_{τ i} ( t ) \qquad ( 5 )$$

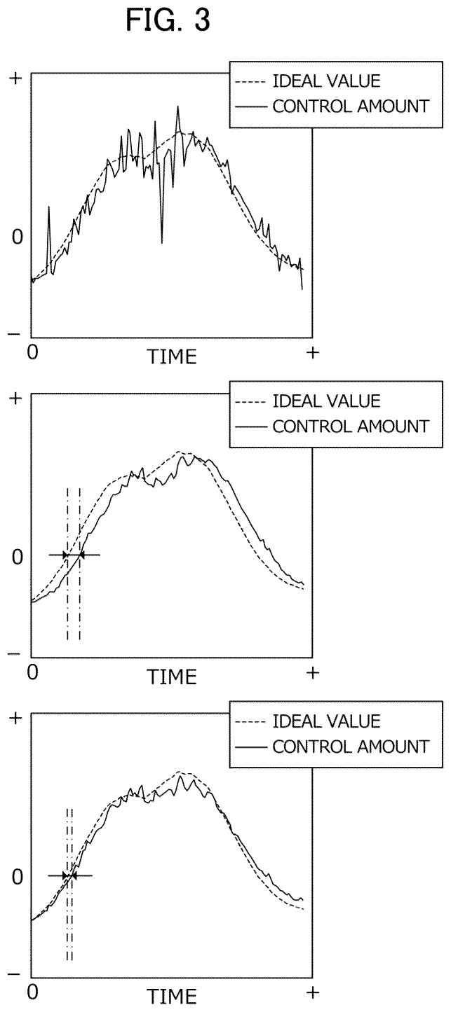

FIG. 3 is a view that compares u_{cmd} calculated by target control amount calculation sections among comparative example 1 (upper level), comparative example 2 (middle level), and the present embodiment (lower level). Note that a later-described ideal control amount for reference is illustrated by broken lines in FIG. 3.

Firstly, the time series data for the input information x, which becomes an input for calculating the target control amount u_{cmd}, includes noise or defects. Accordingly, there are cases where the impact of noise or defects included in the time series data for the input information x directly appears in the target control amount u_{cmd}, which is calculated in accordance with comparative example 1 that employ only input information of a single time as an input, and the target control amount u_{cmd} oscillates as illustrated in the upper level in FIG. 3.

Note that the oscillation as illustrated in the upper level in FIG. 3 can be removed by employing an FIR filter as illustrated in the middle level in FIG. 3. However, simply employing an FIR filter means that past information is dragged, and a delay with respect to the ideal control amount becomes prominent as illustrated in the middle level in FIG. 3.

In contrast, by virtue of the present embodiment, the input information obtainment section 2, the M control amount predictors 3₀, 3₁, 3₂, . . . , 3_{M-1}, and the weighted average calculator 4 are used in combination to calculate the target control amount u_{cmd}(t) as described above, whereby it is possible to simultaneously reduce delay with respect to the ideal control amount while removing the impact of noise or defects included in the time series data for the input information x.

Next, description is given regarding a procedure for using a neural network to construct the M control amount prediction models used in the M control amount predictors 3₀, 3₁, 3₂, . . . , 3_{M-1}.

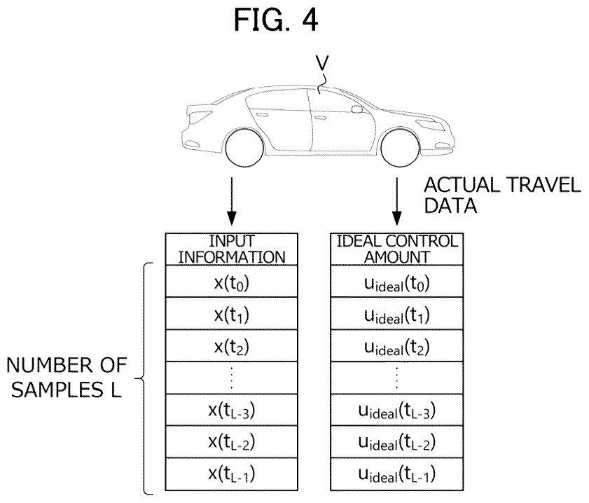

Firstly, as illustrated in FIG. 4, an operator prepares teaching data that will be necessary in order to construct the M control amount prediction models using machine learning. As illustrated in FIG. 4, the teaching data is configured by: a number of samples L (L is an integer that is sufficiently greater than the number of samples M for the input information obtainment section 2) worth of items of time series data for the input information x, [x(t₀), x(t₁), x(t₂), . . . , x(t_{L-3}), x(t_{L-2}), x(t_{L-1})](the number of samples L worth of items of time series data for the input information may be referred to below as “input sample data”); and, with respect to the input sample data, the number of samples L worth of items of time series data for a number of samples L worth of ideal control amounts u_{ideal}, [u_{ideal}(t₀), u_{ideal}(t₁), u_{ideal}(t₂), . . . , u_{ideal}(t_{L-3}), u_{ideal}(t_{L-2}), u_{ideal}(t_{L-1})](the number of samples L worth of items of time series data for the ideal control amount may be referred to below as “ideal output data”). This ideal control amount u_{ideal} corresponds to a control amount that is attempted to be realized in the target control amount calculation section 11.

For such number of samples L worth of items of input sample data and ideal output data, for example, it is possible to use actual travel data obtained when an exemplary driver, who can manually realize an ideal driving operation, has manual driven the vehicle V for a prescribed time period. More specifically, for the number of samples L worth of items of input sample data, it is possible to use time series data for the input information x obtained by the input information obtainment section 2 when the above-described exemplary driver manually drove the vehicle V for the prescribed time period. In addition, for the ideal output data with respect to this input sample data, it is possible to use time series data for the control amount u manually realized by the above-described exemplary driver in the same time period as the time period in which the above-described input sample data was obtained.

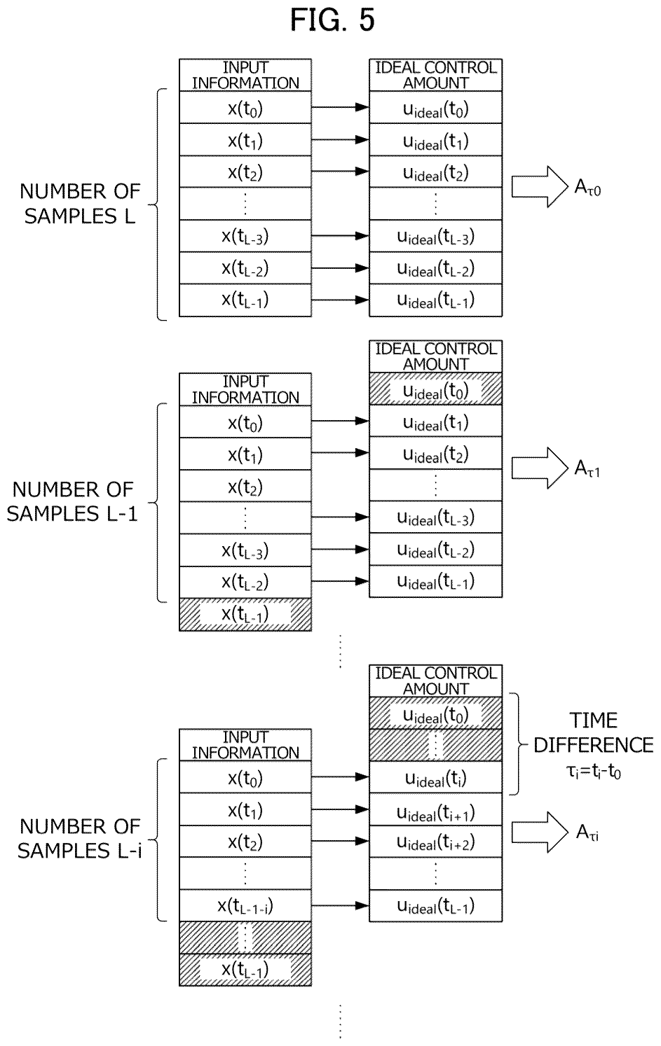

Next, the operator constructs the M control amount prediction models in order using machine learning in which the input sample data and ideal output data prepared using a procedure such as that above is employed as teaching data. For example, the i-th control amount prediction model is constructed using L−i groups of teaching data in which the number of samples L worth of items of input sample data and ideal output data, which has been advanced by an amount of prediction time τᵢ (=tᵢ−t₀) with respect to this input sample data, are employed as a set, as illustrated in FIG. 5.

In other words, the 0-th control amount prediction model for which the amount of prediction time is 0 is constructed using L groups of teaching data in which the input sample data [x(t₀), x(t₁), . . . , x(t_{L-2}), x(t_{L-1})] and the ideal output data [u_{ideal}(t₀), u_{ideal}(t₁), . . . , u_{ideal}(t_{L-2}), u_{ideal}(t_{L-1})] as of the same times are employed as a set, as illustrated in the upper level of FIG. 5. The first control amount prediction model for which the amount of prediction time is τ₁(=t₁−t₀) is constructed using L−1 groups of teaching data in which the input sample data [x(t₀), x(t₁), . . . , x(t_{L-3}), x(t_{L-2})] and the ideal output data [u_{ideal}(t₁), u_{ideal}(t₂), . . . , u_{ideal}(t_{L-2}), u_{ideal}(t_{L-1})] resulting from advancing the times for this input sample data by the amount of prediction time τ₁ are employed as a set, as illustrated in the middle level of FIG. 5. The i-th control amount prediction model for which the amount of prediction time is τᵢ(=tᵢ−t₀) is constructed using L−i groups of teaching data in which the input sample data [x(t₀), x(t₁), . . . x(t_{L-2-i}), x(t_{L-1-i})] and the ideal output data [u_{ideal}(t₁), . . . , u_{ideal}(tᵢ₊₁), . . . , u_{ideal}(t_{L-2}), u_{ideal}(t_{L-1})] as of times resulting from advancing the times for this input sample data by the amount of prediction time τᵢ are employed as a set, as illustrated in the lower level of FIG. 5.

A weighting coefficient A_{τi} for a neural network characterized by the input/output characteristic of the i-th control amount prediction model is determined in accordance with a known algorithm such that an error function E(A_{τi}) defined using L−i groups of teaching data as described above becomes a minimum, as indicated by the following formulas (6-1) and (6-2).

$$E ( {A}_{τ i} ) = {\sum }_{k = 0}^{L - 1 - i} {( {u}_{ideal} ( {t}_{k + i} ) - f ( x ( {t}_{k} ) , {A}_{τ i} ) )}^{2} \qquad ( 6 - 1 )$$

$${A}_{τ i} = {argmin}_{{A}_{τ i}} E ( {A}_{τ i} ) \qquad ( 6 - 2 )$$

By virtue of the vehicle control apparatus 1 according to the present embodiment, the following effects are achieved.

(1) The target control amount calculation section 11, based on time series data for the input information x, calculates the target control amount u_{cmd} for the control amount u defined for the control subject, and the motor drive section 12 operates the control subject based on the calculated target control amount u_{cmd}. In addition, the target control amount calculation section 11 is provided with: the input information obtainment section 2 that obtains the input information [x(t−τ₀), x(t−τ₁), x(t−τ₂), . . . x(t−τ_{M-1})] as of M different times during the prescribed amount of time IM before the current time t; the M control amount predictors 3₀, 3₁, 3₂, . . . , 3_{M-1} that calculate predicted control amounts [u_{τ0}(t), u_{τ1}(t), u_{τ2} (t), . . . , u_{τM-1}(t)] based on the input information as of each of the M times; and the weighted average calculator 4 that calculates, as the target control amount u_{cmd}(t), a weighted average value of the M predicted control amounts [u_{τ0}(t), u_{τ1}(t), u_{τ2}(t), . . . , u_{τM-1}(t)] calculated thereby. By virtue of the vehicle control apparatus 1, it is possible to calculate the weighted average value of the M predicted control amounts [u_{τ0}(t), u_{τ1}(t), u_{τ2}(t), . . . , u_{τM-1}(t)] as the target control amount u_{cmd}(t), whereby the impact due to noise or defects included in time series data for input information is suppressed and the target control amount u_{cmd}(t) having little oscillation is calculated. In addition, in the present invention, the i-th control amount predictor 3ᵢ from among the M control amount predictors 3₀, 3₁, 3₂, . . . , 3_{M-1} calculates the predicted control amount u_{τi}(t) by using a control amount prediction model that associates input information x(t−τ₁) as of a time that is the amount of prediction time τᵢ before the current time t with the control amount u(t) as of the current time t. In other words, the control amount predictors 3₀, 3₁, 3₂, . . . , 3_{M-1} respectively calculate, as the predicted control amounts [u_{τ0}(t), u_{τ1}(t), u_{τ2}(t), . . . , u_{τM-1}(t)], the control amount as of the same current time based on input information as of the different times. Accordingly, by virtue of the vehicle control apparatus 1, it is possible to realize control having little delay while suppressing an impact due to noise or defects included in time series data for input information, and it is consequently possible to contribute to the development of a sustainable transport system.

(2) In the vehicle control apparatus 1, the control amount predictors 3₀, 3₁, 3₂, . . . , 3_{M-1} each calculate a predicted control amount from the input information by using a control amount prediction model constructed using machine learning in which input sample data (time series data for the input information) and ideal output data (time series data for an ideal control amount with respect to the input sample data) are employed as teaching data. Accordingly, by virtue of the vehicle control apparatus 1, it is possible to realize ideal control that has little delay while suppressing the impact of noise or defects included in time series data for input information.

(3) In the vehicle control apparatus 1, the i-th control amount predictor 3ᵢ calculates a predicted control amount u_{τi}(t) as of the current time t from input information x(t−τᵢ) as of an amount of prediction time τᵢ before the current time t by using an i-th control amount prediction model constructed using teaching data in which input sample data and the ideal output data resulting from advancing time with respect to the input sample data by the amount of prediction time τᵢ are employed as a set. Accordingly, by virtue of the vehicle control apparatus 1, it is possible to realize ideal control that has little delay while suppressing the impact of noise or defects included in time series data for input information.

(4) In the vehicle control apparatus 1, the weighted average calculator 4 sets the i-th weight wᵢ for the predicted control amount u_{τi}(t) calculated by the i-th control amount predictor 3ᵢ to a value greater than the j-th (j is an integer greater than i) weight we for the predicted control amount u_{τj}(t) calculated by the j-th control amount predictor 3j. In other words, the weighted average calculator 4 sets the weight wᵢ for the i-th predicted control amount u_{τi}(t), which is calculated based on the input information x(t−τᵢ) as of the amount of prediction time τᵢ before the current time t, to a value greater than the weight we for the j-th predicted control amount u_{τj}(t), which is calculated based on the input information x(t−τⱼ) as of the amount of prediction time τⱼ ago, which is further in the past. There is typically a tendency for the prediction accuracy of a predicted control amount to increase the closer the time of input information is to the current time. The weight is set to a greater value in alignment with the rise in prediction accuracy, whereby it is possible to calculate a target control amount u_{cmd} that is highly accurate.

(5) In the vehicle control apparatus 1, the weighted average calculator 4 sets a value for the k-th (k is an integer between 0 through M−1) weight wₖ such that the k-th weight exponentially decreases with respect to the value of k. As a result, it is possible to use a simple computation to calculate a target control amount u_{cmd} that has high accuracy.

(6) In the vehicle control apparatus 1, the target control amount calculation section 11, based on time series data for input information that includes external information regarding the periphery of the vehicle, calculates the target control amount u_{cmd} for a steering angle in accordance with the electric power-steering apparatus 9 by using a procedure as described above, and the motor drive section 12 operates the electric power-steering apparatus 9 based on the calculated target control amount u_{cmd}. Accordingly, by virtue of the vehicle control apparatus 1, it is possible to realize steering control that has little delay while suppressing the impact of noise or defects included in time series data for external information.

(7) In the vehicle control apparatus 1, a target control amount calculator configured by the automatic travel drive control module, based on time series data for input information that includes external information regarding the periphery of the vehicle, calculates a target control amount for a travel drive force in accordance with the power plant 8 by using a procedure as described above, and the automatic operator operates the power plant 8 based on the calculated target control amount. Accordingly, by virtue of the vehicle control apparatus 1, it is possible to realize travel drive force control that has little delay while suppressing the impact of noise or defects included in external information.

(8) In the vehicle control apparatus 1, a target control amount calculator configured by the automatic braking control module, based on time series data for input information that includes external information regarding the periphery of the vehicle, calculates a target control amount for a braking force in accordance with the braking apparatus 7 by using a procedure as described above, and the automatic operator operates the braking apparatus 7 based on the calculated target control amount. Accordingly, by virtue of the vehicle control apparatus 1, it is possible to realize braking control that has little delay while suppressing the impact of noise or defects included in external information.

### Second Embodiment

Next, with reference to the drawings, description is given regarding a vehicle control apparatus according to a second embodiment of the present invention. Note that, in the following description, the same reference symbols are added to the same configurations as those of the vehicle control apparatus 1 according to the first embodiment, and detailed description thereof is omitted.

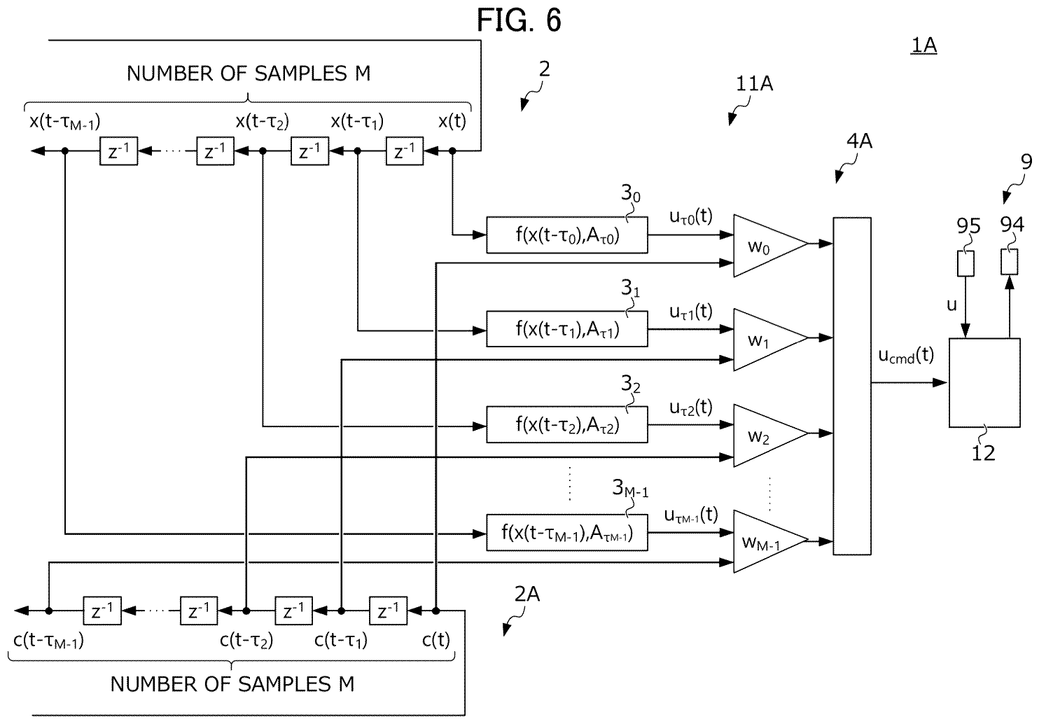

FIG. 6 is a view that illustrates a configuration of the automatic steering control module that pertains to control of an electric power-steering apparatus 9, from among a vehicle control apparatus 1A according to the present embodiment. Note that, because the configurations of the automatic travel drive control module and the automatic braking control module are substantially the same as the configuration of the automatic steering control module illustrated in FIG. 6, detailed description thereof is omitted.

As illustrated in FIG. 6, a target control amount calculation section 11A is provided with: an input information obtainment section 2; a reliability level obtainment section 2A; M control amount predictors 3₀, 3₁, . . . , 3_{M-1}; and a weighted average calculator 4A.

The reliability level obtainment section 2A obtains, from the external recognition apparatus 65, time series data regarding a reliability level c with respect to time series data for the input information x obtained by the input information obtainment section 2. More specifically, the reliability level obtainment section 2A obtains reliability levels [c(t−τ₀), c(t−τ₁), c(t−τ₂), . . . , c(t−τ_{M-1})] that respectively pertain to M items of input information [x(t−τ₀), x(t−τ₁), x(t−τ₂), . . . x(t−τ_{M-1})] obtained by the input information obtainment section 2. In other words, the reliability level c(t−τ₀) is a reliability level with respect to the input information x(t−τ₀) as of the same time, the reliability level c(t−τ₁) is the reliability level with respect to input information x(t−τ₁) as of the same time, and the reliability level c(t−τ_{M-1}) is the reliability level with respect to the input information x(t−τ_{M-1}) as of the same time.

As indicated in the following formulas (7-1) and (7-2), the weighted average calculator 4A calculates, as the target control amount u_{cmd}(t), a weighted average value under weights that correspond to the reliability levels [c(t−τ₀), c(t−τ₁), c(t−τ₂), . . . , c(t−τ_{M-1})] obtained by the reliability level obtainment section 2A for the M predicted control amounts [u_{τ0}(t), u_{τ1}(t), u_{τ2}(t), . . . , u_{τM-1}(t)] calculated by the M control amount predictors 3₀, 3₁, 3₂, . . . , 3_{M-1}, and inputs the weighted average value to the motor drive section 12.

$${u}_{c m d} ( t ) = \frac{1}{{S}_{w}} {\sum }_{k = 0}^{M - 1} {w}_{k} ( c ( t - {τ}_{k} ) ) f ( x ( t - {τ}_{k} ) , {A}_{τ k} ) \qquad ( 7 - 1 )$$

$${S}_{w} = {\sum }_{k = 0}^{M - 1} {w}_{k} ( c ( t - {τ}_{k} ) ) \qquad ( 7 - 2 )$$

In the abovementioned formulas (7-1) and (7-2), “wₖ(c(t−τₖ))” is the k-th weight for the k-th predicted control amount u_{τk}(t), and is a function of the k-th reliability level c(t−τₖ) with respect to the k-th item of input information x(t−τₖ). More specifically, it is desirable for the weighted average calculator 4A to set the weight wₖ(c(t−τₖ)) to a smaller value as the amount of prediction time τₖ lengthens. It is also desirable for the weighted average calculator 4A to set the weight wₖ(c(t−τₖ)) to a smaller value as the reliability level c(t−τₖ) decreases, in other words, as the reliability level of the k-th item of input information x(t−τₖ) decreases.

By virtue of the vehicle control apparatus 1A according to the present embodiment, in addition to the effects indicated by the abovementioned (1) through (8), the following effect is achieved.

(9) In the vehicle control apparatus 1A, the reliability level obtainment section 2A obtains the reliability level c(t−τᵢ) with respect to input information x(t−τ₁) as of the amount of prediction time τᵢ before the current time t, and the weighted average calculator 4A sets a value for the i-th weight wᵢ(c(t−τᵢ)) based on the i-th obtained reliability level c(t−τᵢ). As a result, it is possible to calculate a highly accurate target control amount u_{cmd} by reflecting the reliability level c for input information x as of various times.

### Third Embodiment

Next, with reference to the drawings, description is given regarding a vehicle control apparatus according to a third embodiment of the present invention. Note that, in the following description, the same reference symbols are added to the same configurations as those of the vehicle control apparatus 1 according to the first embodiment, and detailed description thereof is omitted.

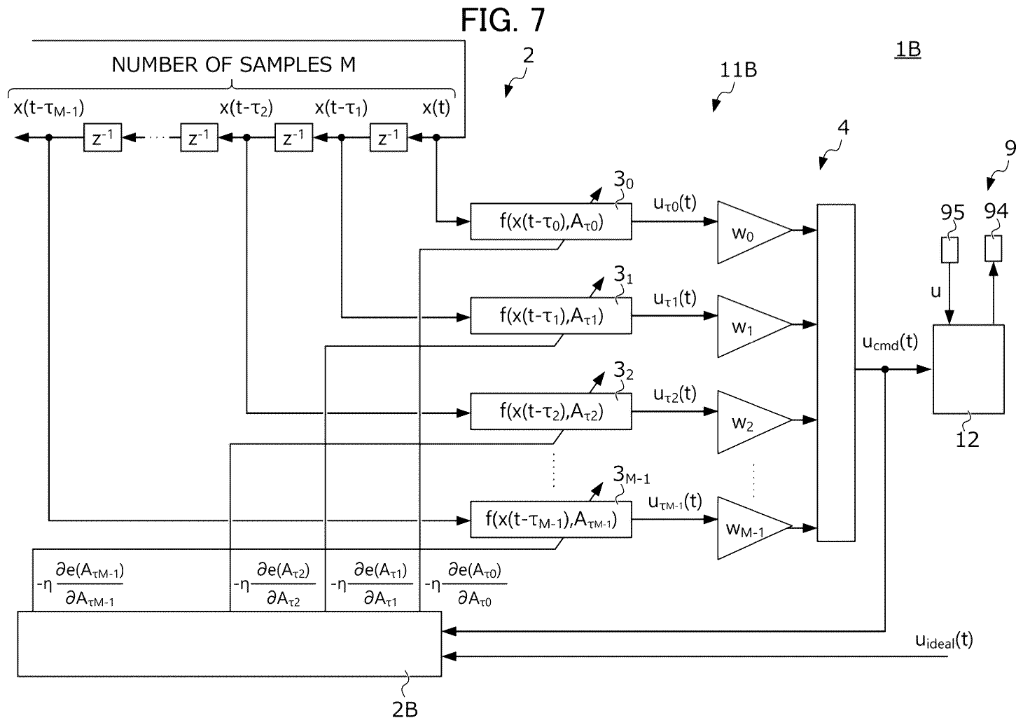

FIG. 7 is a view that illustrates a configuration of the automatic steering control module that pertains to control of an electric power-steering apparatus 9, from among a vehicle control apparatus 1B according to the present embodiment. Note that, because the configurations of the automatic travel drive control module and the automatic braking control module are substantially the same as the configuration of the automatic steering control module illustrated in FIG. 7, detailed description thereof is omitted.

As illustrated in FIG. 7, a target control amount calculation section 11B is provided with: an input information obtainment section 2; a training apparatus 2B; M control amount predictors 3₀, 3₁, . . . , 3_{M-1}, and a weighted average calculator 4.

The training apparatus 2B trains the control amount prediction models for the control amount predictors 3₀, 3₁, . . . 3_{M-1} based on the time series data for the input information x and the control amount u as of a time of manual driving in which the driver of the vehicle V is set as an agent who operates the electric power-steering apparatus 9 that is a control subject.

More specifically, the training apparatus 2B calculates an error function e(A_{τi}) defined by the following formula (8-1), based on time series data such as the input information x and the control amount u obtained while the driver is manually operating the electric power-steering apparatus 9. In addition, as indicated in the following formula (8-2), the training apparatus 2B sequentially adds an update amount (the second term on the right side of formula (8-2)) defined using gradient descent to the parameter A_{τi}, which characterizes an input/output characteristic of the i-th control amount prediction model, to thereby update the i-th control amount prediction model.

$$e ( {A}_{τ i} ) = {( {u}_{ideal} ( t ) - f ( x ( t - {τ}_{i} ) , {A}_{τ i} ) )}^{2} \qquad ( 8 - 1 )$$

$${A}_{τ i}^{′} = {A}_{τ i} - η \frac{\partial e ( {A}_{τ i} )}{\partial {A}_{τ i}} \qquad ( 8 - 2 )$$

In the abovementioned formula (8-1), “u_{ideal}” is an ideal control amount, and it is possible to use time series data for the control amount u, which is manually realized by the driver, as “u_{ideal}”. In addition, “η” in the abovementioned formula (8-2) indicates a training rate, and is set to a predefined value.

By virtue of the vehicle control apparatus 1B according to the present embodiment, in addition to the effects indicated by the abovementioned (1) through (8), the following effect is achieved.

(10) In the vehicle control apparatus 1B, the training apparatus 2B trains M control amount prediction models based on time series data for the input information x and the control amount u as of a time of manual driving in which a driver of the vehicle V is an agent who operates the control subject. Accordingly, by virtue of the vehicle control apparatus 1B, it is possible to cause the input/output characteristics of the M control amount prediction models to change in accordance with change over time by characteristics of the driver of the vehicle V and by characteristics of the sensor unit 6, which is for obtaining external information.

Description was given above for an embodiment of the present invention, but the present invention is not limited thereto. The detailed configuration may be changed, as appropriate, within the scope of the purport of the present invention.

What is claimed is:

1. A control apparatus that calculates, based on input information, a target control amount with respect to a control amount defined for a control subject, and operates the control subject based on the target control amount, the control apparatus comprising:
a target control amount calculator configured to calculate the target control amount based on time series data for the input information; and
an automatic operator configured to operate the control subject based on the target control amount, wherein
the target control amount calculator comprises
an input information obtainer configured to obtain the input information as of M (M is an integer greater than or equal to 2) different times during a prescribed amount of time before a current time,
M control amount predictors each configured to calculate a predicted control amount based on the input information obtained by the input information obtainer, and
a weighted average calculator configured to calculate, as the target control amount, a weighted average value of the M predicted control amounts calculated by the M control amount predictors, and
an i-th (i is an integer between 0 through M−1) control amount predictor calculates the predicted control amount by using a control amount prediction model that associates the input information as of an i amount of time before the current time with the control amount as of the current time.

2. The control apparatus according to claim 1, wherein
the control amount prediction model is constructed using machine learning in which input sample data that is time series data for the input information and ideal output data that is time series data for an ideal control amount with respect to the input sample data are employed as teaching data.

3. The control apparatus according to claim 2, wherein
an i-th control amount prediction model is constructed using the teaching data, in which the input sample data and the ideal output data resulting from advancing time with respect to the input sample data by the i amount of time are employed as a set.

4. The control apparatus according to claim 1, wherein
the weighted average calculator sets an i-th weight for the predicted control amount calculated by the i-th control amount predictor to a value greater than a j-th (j is an integer greater than i) weight for the predicted control amount calculated by a j-th control amount predictor.

5. The control apparatus according to claim 4, wherein
the weighted average calculator sets a value for a k-th (k is an integer between 0 through M−1) weight such that the k-th weight exponentially decreases with respect to a value of k.

6. The control apparatus according to claim 5, wherein
the target control amount calculator further comprises a reliability level obtainer configured to obtain a reliability level of the input information as of the i amount of time before the current time, and
the weighted average calculator sets the value of the i-th weight based on an i-th reliability level obtained by the reliability level obtainer.

7. The control apparatus according to claim 2, wherein
the weighted average calculator sets an i-th weight for the predicted control amount calculated by the i-th control amount predictor to a value greater than a j-th (j is an integer greater than i) weight for the predicted control amount calculated by a j-th control amount predictor.

8. The control apparatus according to claim 7, wherein
the weighted average calculator sets a value for a k-th (k is an integer between 0 through M−1) weight such that the k-th weight exponentially decreases with respect to a value of k.

9. The control apparatus according to claim 8, wherein
the target control amount calculator further comprises a reliability level obtainer configured to obtain a reliability level of the input information as of the i amount of time before the current time, and
the weighted average calculator sets the value of the i-th weight based on an i-th reliability level obtained by the reliability level obtainer.

10. The control apparatus according to claim 3, wherein
the weighted average calculator sets an i-th weight for the predicted control amount calculated by the i-th control amount predictor to a value greater than a j-th (j is an integer greater than i) weight for the predicted control amount calculated by a j-th control amount predictor.

11. The control apparatus according to claim 10, wherein
the weighted average calculator sets a value for a k-th (k is an integer between 0 through M−1) weight such that the k-th weight exponentially decreases with respect to a value of k.

12. The control apparatus according to claim 11, wherein
the target control amount calculator further comprises a reliability level obtainer configured to obtain a reliability level of the input information as of the i amount of time before the current time, and
the weighted average calculator sets the value of the i-th weight based on an i-th reliability level obtained by the reliability level obtainer.

13. The control apparatus according to claim 1, wherein
the control subject is a steerer in a vehicle,
the control amount is a steering angle that is in accordance with the steerer, and
the input information includes external information pertaining to a periphery of the vehicle.

14. The control apparatus according to claim 13, further comprising:
a trainer configured to train the control amount prediction model based on time series data for the input information and the control amount as of a time of manual driving in which a driver of the vehicle is an agent who operates the control subject.

15. The control apparatus according to claim 1, wherein
the control subject is a travel driver in a vehicle,
the control amount is a travel drive force that is in accordance with the travel driver, and
the input information includes external information pertaining to a periphery of the vehicle.

16. The control apparatus according to claim 15, further comprising:
a trainer configured to train the control amount prediction model based on time series data for the input information and the control amount as of a time of manual driving in which a driver of the vehicle is an agent who operates the control subject.

17. The control apparatus according to claim 1, wherein
the control subject is a brake in a vehicle,
the control amount is a braking force in accordance with the brake, and
the input information includes external information pertaining to a periphery of the vehicle.

18. The control apparatus according to claim 17, further comprising:
a trainer configured to train the control amount prediction model based on time series data for the input information and the control amount as of a time of manual driving in which a driver of the vehicle is an agent who operates the control subject.

19. A control method that uses a computer to control a control amount defined for a control subject, the control method comprising:
obtaining input information as of M (M is an integer that is greater than or equal to 2) different times during a prescribed amount of time before a current time;
calculating M predicted control amounts based on the input information as of the M different times;
calculating, as a target control amount for the control amount, a weighted average value of the M predicted control amounts; and
operating the control subject based on the target control amount, wherein
the calculating the M predicted control amounts includes calculating an i-th (i is an integer between 0 through M−1) predicted control amount by using a control amount prediction model that associates the input information as of an i amount of time before the current time with the control amount as of the current time.

20. A storage medium that stores a computer program for causing a computer to control a control amount defined for a control subject, wherein
the computer program causes the computer to perform operations that comprise:
obtaining input information as of M (M is an integer that is greater than or equal to 2) different times during a prescribed amount of time before a current time,
calculating M predicted control amounts based on the input information as of the M different times;
calculating, as a target control amount for the control amount, a weighted average value of the M predicted control amounts, and
operating the control subject based on the target control amount, and
the calculating the M predicted control amounts includes calculating an i-th (i is an integer between 0 through M−1) predicted control amount by using a control amount prediction model that associates the input information as of an i amount of time before the current time with the control amount as of the current time.
